(19) United States
(12) Patent Application Publication
(10) Pub. No.: US 2026/0359322 A1
(43) Pub. Date: Nov. 12, 2026

(54) System and Method for Migrating Data From Mainframe Computing Environments to Cloud Computing Environments

(71) Applicant: The Toronto-Dominion Bank, Toronto (CA)

(72) Inventor: Syrous DELAVARI-MARAGHI, Vaughan (CA)

(73) Assignee: The Toronto-Dominion Bank, Toronto (CA)

(21) Appl. No.: 19/202,160

(22) Filed: May 8, 2025

(51) Int. Cl. G06F 16/27

(52) U.S. Cl. CPC G06F 16/273

(57) ABSTRACT

System, method and device for migrating data from mainframe computing environments to cloud computing environments. The method includes having an I/O module maintain an activity log of data transaction events executed in a mainframe computing environment, interfacing with an application currently being used in the mainframe computing environment, having an event monitoring system access the activity log periodically to create new events, providing microservices to receive updates based on data transactions detected in the mainframe, and rerouting data transactions intended for the mainframe to the microservices and have a reconciliation service update the cloud environment.

### TECHNICAL FIELD

The following relates generally to methods for data migration, and more specifically to migrating data from mainframe computing environments to cloud computing environments.

### BACKGROUND

Legacy mainframe applications and systems, including databases like information management system (IMS) databases and DB2 relational databases, are typically found to be integral to many organizations but can pose significant modernization challenges.

Migrating these applications to a cloud computing environment may offer a transformative opportunity to reduce complexity and cost. However, operational data that resides in IMS and relational database management system (RDBMS) databases (e.g., hierarchical and relational) may have been developed over many years (e.g., over a generation of users). Similarly, IMS databases are found to be housed exclusively on mainframes in many enterprises. Distributed applications may rely on costly IMS transactions and access both IMS segments and RDBMS tables through mainframe processes, creating reliance on outdated, rigid architectures.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of a legacy integration layer used in a mainframe computing environment.

FIG. 3 is a block diagram of an example of a data migration system.

FIG. 4 illustrates an example of a configuration for implementing the data migration system of FIG. 3.

FIG. 5 illustrates a configuration for an event hub microservice.

FIG. 6 illustrates a configuration for a cloud microservice.

FIG. 7 is a block diagram of an example configuration of an enterprise system.

FIG. 8 is a block diagram of an example configuration of a client device used to interface with, for example, the self-serve data platform.

FIG. 9 is a flow chart illustrating example operations that may be performed in migrating data from mainframe computing environments to cloud computing environments.

FIG. 10 is a flow chart illustrating example operations that may be performed in initiating an input/output (I/O) module to begin populating an activity log for an application being migrated.

FIG. 11 is a flow chart illustrating example operations that may be performed in reconciling data event transactions in a cloud environment that are detected in a mainframe environment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Several core technical challenges can exist that provide resistance to migrating mainframe data to a cloud platform. For instance, enterprises often have legacy interfaces and user experiences that are difficult to transition from. In one example, mainframe systems still use “green screen” interfaces and Job Control Language (JCL) jobs, which may limit flexibility and require specialized skills. These interfaces, designed decades ago, are normally incompatible with modern, user-friendly interfaces and cloud-based services that demand ease of interaction.

Similarly, monolithic system constraints may exist, where green screens and JCL jobs are integral to monolithic mainframe architectures, making modularity difficult. This architecture hinders the migration to decentralized services, containerization, and cloud-native environments that require more adaptability.

With respect to data governance and security compliance, legacy systems present challenges for meeting current regulatory requirements (e.g., GDPR) and security governance, especially when trying to bridge mainframe-based data with cloud environments. Maintaining compliance and securing data across distributed platforms introduces complexity. These legacy systems also are found to have real-time data processing limitations. For example, traditional mainframe processes may rely heavily on JCL batch jobs, whereas cloud applications are designed for real-time data streaming and processing. Bridging these processing models without disrupting data flow creates operational hurdles.

Current systems may also have proprietary dependencies and integration issues where the mainframe system's reliance on proprietary hardware and software (e.g., IBM z/OS), batch-oriented nature (JCLs) and green screens, make it challenging to integrate with open cloud platforms. This dependency can slow down innovation, increase maintenance costs (e.g., million instructions per second (MIPS) costs), and limit compatibility with modern technology stacks.

To address these challenges, the system described herein provides a pattern to efficiently transfer data, preserve legacy data structures, process and filter data at the edge, and maintain real-time data synchronization. This pattern enables seamless integration from mainframe computing environments and systems to cloud applications while optimizing data security and compliance.

The system is configured to enable seamless integration for upstream and downstream applications, supporting real-time data inquiries and event-driven subscriptions for immediate changes. The pattern facilitates the transfer of data and core processes, including green screens and JCL jobs, to a cloud-native environment. By preserving essential functionalities, and ensuring seamless integration with existing systems, this approach enables real-time data consistency, security, and compliance while maintaining compatibility with legacy structures. The result is a modernized, scalable system that enhances operational efficiency without disrupting consumer applications.

According to one aspect, a system for migrating data from mainframe computing environments to cloud computing environments is provided. The system includes a processor, and a memory coupled to the processor. The memory stores computer executable instructions that when executed by the processor cause the system to have an input/output (I/O) module maintain an activity log of data transaction events executed in a mainframe computing environment for at least one legacy application, the mainframe computing environment being transitioned at least in part to a cloud computing environment; interface with an application currently being used in the mainframe computing environment and usable in the cloud computing environment; have an event monitoring system access the activity log periodically to create new events to be updated in the cloud computing environment; provide at least one application microservice to receive updates based on data transactions detected in the mainframe computing environment; and reroute data transactions intended for the mainframe computing environment to the at least one microservice and have a reconciliation service update the cloud computing environment based on data transactions occurring in the mainframe computing environment.

In certain example embodiments, the system is further configured to detect that new data transactions associated with the application are being rerouted away from the mainframe computing environment and that prior mainframe data transactions have been reconciled; and decommission mainframe operations for the application.

In certain example embodiments, the activity log is utilized while data transactions are capable of being updated in the mainframe.

In certain example embodiments, the system is further configured to initiate the I/O module to populate the activity log for the application in response to a data migration event for the application.

In certain example embodiments, the activity log is connected to at least one legacy database in the mainframe to determine new data transaction events.

In certain example embodiments, the system includes a plurality of legacy databases, wherein the plurality of legacy databases comprises at least one information management system (IMS) database and at least one DB2 relational database.

In certain example embodiments, the at least one legacy database is utilized by at least one legacy service, at least one legacy batch job, or both.

In certain example embodiments, the system is further configured to coordinate the reconciliation service with an event hub microservice in an event hub; subscribe to events that are detectable from the application and from the activity log in parallel; and reconcile data event transactions in the cloud computing environment that are detected in the mainframe computing environment.

In certain example embodiments, the system includes a plurality of application microservices, wherein application microservices are created over time to add functionality to the cloud computing environment that is decommissioned from the mainframe computing environment.

In certain example embodiments, the reconciliation service subscribes to topics associated with the activity log to detect the data transaction events using the event monitoring system.

In certain example embodiments, the event monitoring system is provided by infrastructure in an enterprise platform.

In certain example embodiments, the at least one microservice utilizes a GraphQL contract.

In another aspect, there is provided a method for migrating data from mainframe computing environments to cloud computing environments. The method includes having an I/O module maintain an activity log of data transaction events executed in a mainframe computing environment for at least one legacy application, the mainframe computing environment being transitioned at least in part to a cloud computing environment; interfacing with an application currently being used in the mainframe computing environment and usable in the cloud computing environment; having an event monitoring system access the activity log periodically to create new events to be updated in the cloud computing environment; providing at least one application microservice to receive updates based on data transactions detected in the mainframe computing environment; and rerouting data transactions intended for the mainframe computing environment to the at least one microservice and have a reconciliation service update the cloud computing environment based on data transactions occurring in the mainframe computing environment.

In certain example embodiments, the method further includes detecting that new data transactions associated with the application are being rerouted away from the mainframe computing environment and that prior mainframe data transactions have been reconciled; and decommissioning mainframe operations for the application.

In certain example embodiments, the activity log is utilized while data transactions are capable of being updated in the mainframe.

In certain example embodiments, the method includes initiating the I/O module to populate the activity log for the application in response to a data migration event for the application.

In certain example embodiments, the activity log is connected to at least one legacy database in the mainframe to determine new data transaction events.

In certain example embodiments, the method further includes coordinating the reconciliation service with an event hub microservice in an event hub; subscribing to events that are detectable from the application and from the activity log in parallel; and reconciling data event transactions in the cloud computing environment that are detected in the mainframe computing environment.

In certain example embodiments, the system includes a plurality of application microservices, wherein application microservices are created over time to add functionality to the cloud computing environment that is decommissioned from the mainframe computing environment.

In another aspect, there is provided a computer readable medium storing computer-executable instructions for migrating data from mainframe computing environments to cloud computing environments. The computer readable instructions include computer-executable instructions that, when executed by a computing system, cause the system to have an I/O module maintain an activity log of data transaction events executed in a mainframe computing environment for at least one legacy application, the mainframe computing environment being transitioned at least in part to a cloud computing environment; interface with an application currently being used in the mainframe computing environment and usable in the cloud computing environment; have an event monitoring system access the activity log periodically to create new events to be updated in the cloud computing environment; provide at least one application microservice to receive updates based on data transactions detected in the mainframe computing environment; and reroute data transactions intended for the mainframe computing environment to the at least one microservice and have a reconciliation service update the cloud computing environment based on data transactions occurring in the mainframe computing environment.

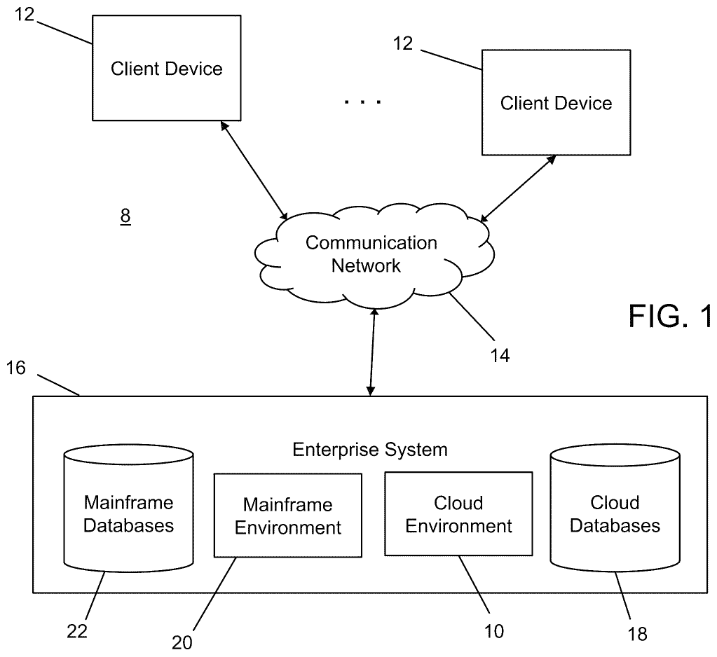

Referring now to the figures, FIG. 1 illustrates an example of a computing environment 8. In one aspect, the computing environment 8 may include one or more client devices 12, and one or more communications networks 14 connecting the components of the computing environment 8.

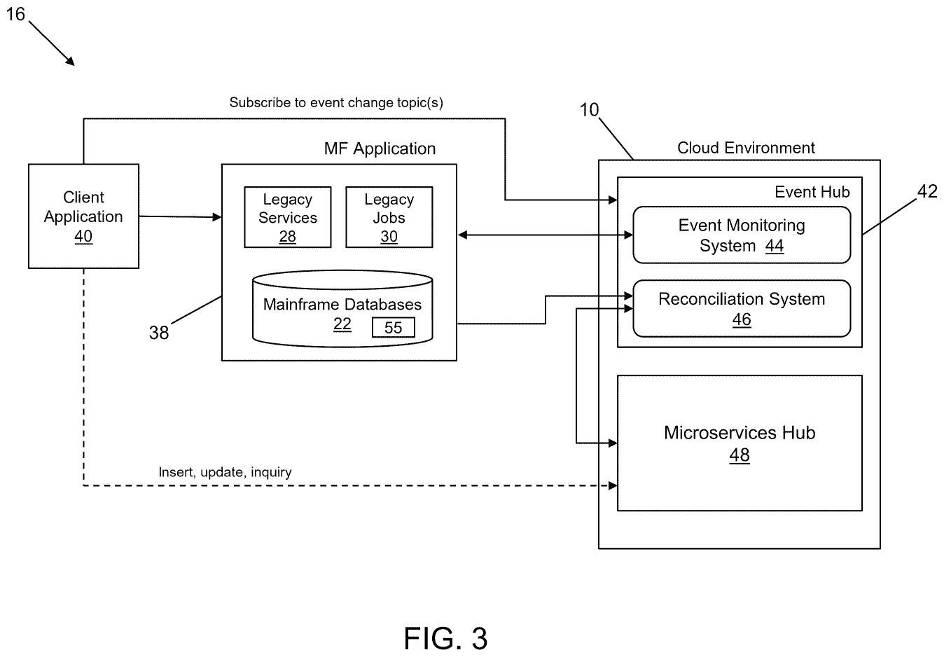

The computing environment 8 may also include an enterprise system 16 (e.g., a financial institution such as a commercial bank and/or insurance provider) that provides financial services accounts to users and processes financial transactions associated with those financial service accounts. While several details of the enterprise system 16 have been omitted for clarity of illustration, reference will be made to FIGS. 3, 4, and 7 below for additional details. The enterprise system 16 includes, at least in part, a mainframe computing environment 20, also referred to herein as the mainframe environment 20 or mainframe 20 for brevity. The mainframe environment 20, as known in the art, may be or comprise one or more high-performance computers designed to handle and process vast amounts of data quickly and reliably. These computers are typically used for large-scale transaction processing, critical applications, and bulk data processing tasks. The enterprise system 16 includes or otherwise has access to one or more mainframe databases 22 for storing data created, stored, accessed and otherwise utilized in/with the mainframe environment 20.

The enterprise system 16 additionally includes a cloud computing environment 10, also referred to herein as the cloud environment 10, a cloud-based environment 10, or the cloud 10 for brevity. The cloud environment 10, as known in the art, includes one or more computing components accessible to the enterprise system 16 that connect to and utilize remote computing resources such as storage, processing, servers and services, in a cloud-based platform, such as Microsoft Azure®, etc. The enterprise system 16 includes or otherwise has access to one or more cloud databases 18 for storing data created, stored, accessed and otherwise utilized in/with the cloud environment 10 in association with the enterprise system 16.

The enterprise system 16 may include other datastores not shown in FIG. 1. The data associated with a user can include client profile data that may be mapped to corresponding financial data for that user. It can be appreciated that the financial data could also include transaction data and/or client data stored in one or both of the databases shown in FIG. 1 and these datastores are described separately for illustrative purposes. The client data can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a mobile or web-based financial (banking) application which uses or incorporates subsystems of the enterprise system 16, discussed further below.

The client devices 12 can access information within the enterprise system 16 or another remote computing environment associated with the enterprise system 16 in a variety of ways. For example, the client device 12 can access the enterprise system 16 via a web-based application, or a dedicated application. Access can require the provisioning of different types of credentials (e.g., login credentials, two factor authentication, etc.). In example embodiments, each different client device 12 can be provided with a unique degree of access, or variations thereof. For example, the client device 12 can be provided with a greater degree of access to the enterprise system 16 compared to other devices such as point of sale (POS) devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be difficult to migrate into a digital and remote computing environment.

The enterprise system 16 may include both on-premises and remote computing assets provided by a remote computing environment associated with the cloud environment 10 instantiated within the enterprise system 16. The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft Azure® data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth. That is, the cloud environment 10 shown in FIG. 1, may represent any module, interface, service, instance, component, device, service or other computing element that is deployed or operated within the enterprise system 16 in a manner that interfaces with a cloud-based resource (not shown).

Referring back to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

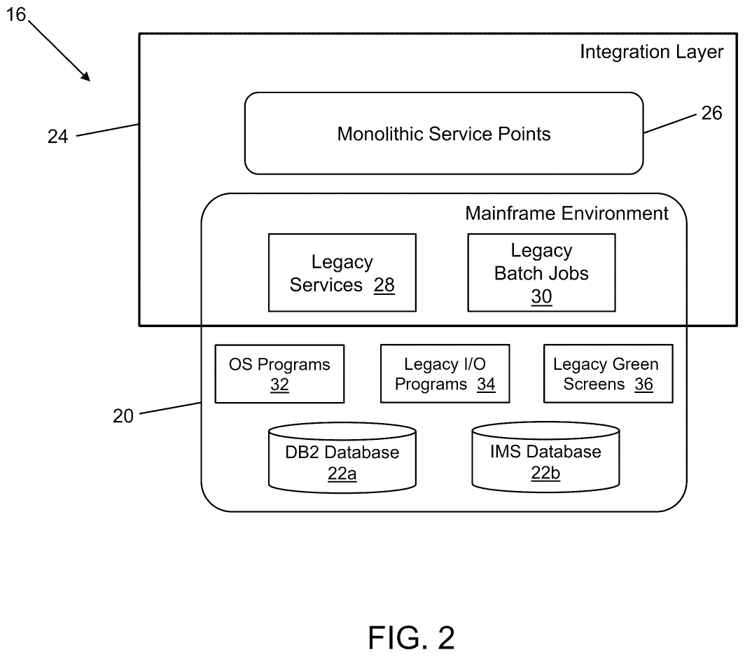

Turning now to FIG. 2, further details of an existing mainframe set-up within an enterprise system 16 are shown. In this example, the mainframe environment 20 is coupled to an integration layer 24 to be utilized by monolithic service points 26, e.g., departments or units in an organization, customer-or internally-facing applications, etc. The integration layer 24 provides access to legacy services 28 and legacy batch jobs 30 in the mainframe environment 20. The legacy services 28 and legacy batch jobs 30 access mainframe databases 22, such as a DB2 database 22a and IMS database 22b as shown by way of example only, by executing OS programs 32, legacy I/O programs 34, and legacy green screens 36 to name a few. It can be appreciated that dozens, hundreds, or even thousands of OS programs 32, legacy I/O programs 34 and legacy green screens 36 may have been developed, deployed and utilized in a patch-work fashion over many years or even decades, making it challenging to transition to more cost-effective and efficient cloud-based versions.

In this example current state, customer data may be stored in legacy IMS database segments and DB2 tables, each with distinct structures and formats. Consumer applications and legacy green screens 36 would then need to connect through the legacy DB2 and IMS databases (22a, 22b), e.g., via z/OS IMS & I/O modules to access customer data in real time. Batch processing jobs handle integration for many consumer applications within a customer interfacing system. Mainframe applications are monolithic, lacking scalability and backward compatibility with modern systems. Operational costs for these customer interfacing systems and its real-time services are notably high, impacting overall productivity and budget.

Mainframe complexity makes changes time consuming and limits benefits like flexibility, scalability and independent deployment available in cloud computing solutions. The integrations with consumers are complex and lack consistency across systems (e.g., application programming interface (API), IMS, WS, JDBC, et al). With dozens or even hundreds of consumer applications integrated into this configuration, modifications and testing become highly intricate and resource intensive. Monolithic mainframe applications (including greens screens 36, COBOL code, and JCL Batches) can hinder change and testing, lacking agility for efficient development. Moreover, green screens 36 are found to be outdated and modifying jobs is challenging.

The proposed configuration shown in FIG. 3 enables data to be transferred and eventually migrate from the mainframe environment 20 to having data at the edge in a cloud environment 10. As shown in FIG. 3, in the migration pattern, configuration or system, a mainframe (MF) application 38 may be envisioned as one or more legacy services 28 and one or more legacy batch jobs 30 that access and utilize at least part of at least one mainframe database 22, e.g., a DB2 or IMS database 22a, 22b.

The client application 40 in this example is assumed to currently, and for at least a migration period, communicate with the MF application 38 in its normal use. In order to migrate data from the MF application 38 to the cloud environment 10, at least one channel is established between the client application 40 and the cloud environment 10 that is in addition to the direct communication link that exists with the MF application 38. In this example, the client application 40 can be connected to an event hub 42 having an event monitoring system 44 to enable the event monitoring system 44 to subscribe to topics associated with changes to the MF application 38 caused by the client application 40. The client application 40 may therefore be configured to generate events for the event monitoring system 44 or otherwise have changes be detectable by the event monitoring system 44 in the event hub 42. The event monitoring system 44 may then be able to determine what data that continues to be updated in the mainframe database(s) 22 needs to be pulled to the cloud environment 10 by a reconciliation process executed by a reconciliation system 46.

The cloud environment 10 is then able to establish a cloud version of the MF application 38 by creating microservices hosted by a microservices hub 48. The client application 40 may then, in parallel, at some point in time, have a channel established directly with the microservices hub 48 for insert, update and inquiry operations. It can be appreciated that the client application 40 may include events that occur both in the MF application 38 and mainframe environment 20 while being usable in or with the cloud environment 10. By having the reconciliation system 46 in the event hub 42 and an activity log 55 maintained for the mainframe databases 22, the enterprise system 16 can begin to reroute or divert client application interactions to the cloud environment 10 by connecting to the microservices hub 48. Once the reconciliation system 46 and/or event monitoring system 44 determine that the client application 40 is no longer populating the activity log 55, the MF application 38 can be decommissioned and new users added to the cloud environment 10 only going forward. By having the configuration shown in FIG. 3, an abrupt and cost prohibitive changeover can be avoided while gradually reducing the costs of running the MF application 38 and ramping up cloud-based resources over time.

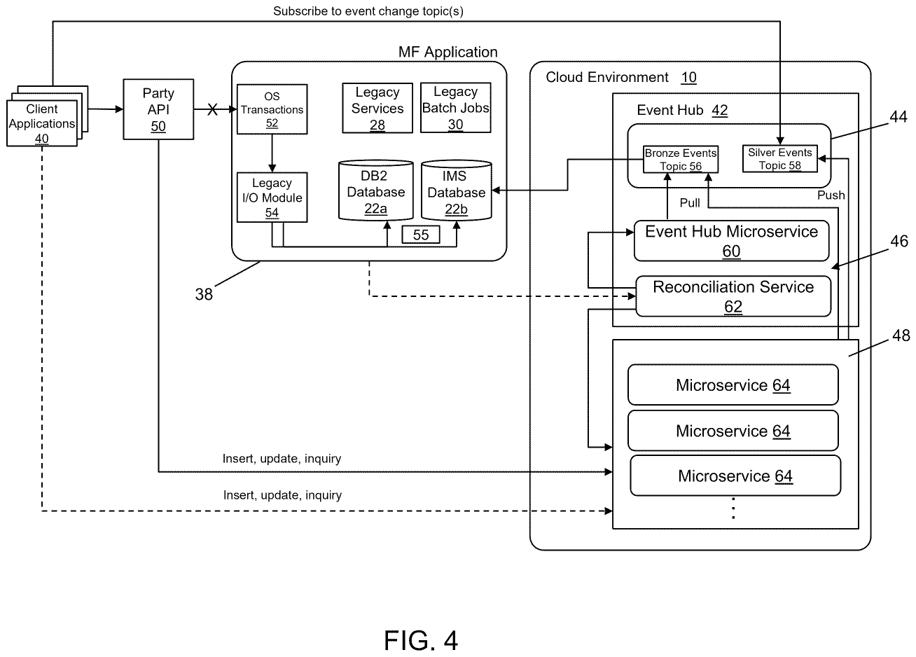

FIG. 4 illustrates one example implementation of the pattern or configuration shown in FIG. 3. In this particular example, a party API 50 may be used as a gateway between the client applications 40 and MF application(s) 38. The party API 50 can connect to an OS transactions module 52 that instructs a legacy I/O module 54 to maintain the activity log 55 in a DB2 database 22a and an IMS database 22b. This allows a bronze events topic 56 in the event monitoring system 44 to access the activity log 55 by subscribing to event change topics. The bronze events topic 56 may then be monitored by an event hub microservice 60, which is connected to a reconciliation service 62 in the reconciliation system 46. A silver events topic 58 can be used to subscribe to the event change topics associated with the client applications 40.

The microservices hub 48 can interface with the silver events topic 58 to push data from the microservices 64. The microservices 64 may pull data from the bronze events topics 56 (e.g., to update from the activity log 55) based on updates determined by the reconciliation service 62 via the event hub microservice 60. The microservices 60, 62, and 64 shown in FIG. 4 are only one example configuration for having events, data transactions, new data, new users and other activities to be detected in the MF application 38 and reconciled in the cloud environment 10 until the MF application 38 can be decommissioned.

As illustrated with the “X”, the party API 50 may insert, update, and inquiry via one channel to the microservices hub 48 until, as shown in dashed lines, a direct channel is used between the client applications 40 and the microservices hub 48 to allow the MF application 38 to be decommissioned. The party API 50 and legacy I/O module 54 may therefore be deployed to intercept, manage, reroute, divert or otherwise influence interactions between the client application(s) 40 and the MF application 38 during a migration period.

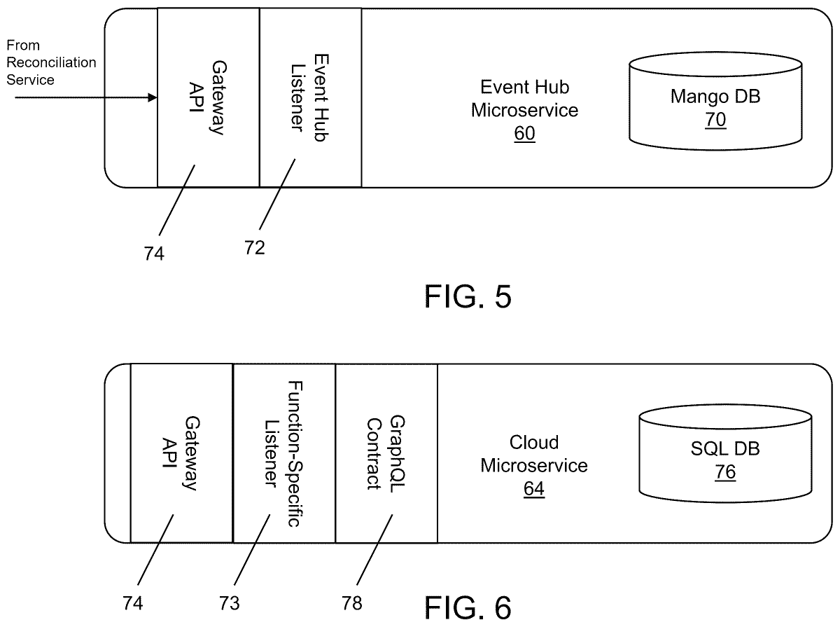

Further details of the event hub microservice 60 are shown in FIG. 5 and further details of the cloud microservice are shown in FIG. 6. Referring first to FIG. 5, the event hub microservice 60 includes a mange database (DB) 70 and an event hub listener 72 that uses a gateway API 74 to pull event data and provide this event data to the reconciliation service 62. Similarly, as shown in FIG. 6, the cloud microservice 64 includes an SQL DB 76 and a GraphQL contract 78 to communicate with the appropriate cloud-based server (not shown). The cloud microservice 64 also includes a function-specific listener 73 (e.g., consumer profile listener, business profile listener, alternative party listener, etc.) and a gateway API 74.

It can be appreciated that, in terms of system modernization, the pattern shown in FIGS. 3 and 4 enables migration from legacy mainframe configurations to distributed-and cloud-based configurations. For integration optimization, it reduces the amount of batch processing. For event enablement, it brings legacy applications to “live” and near real-time processing. And, for application modernization, it can decrease number of legacy applications, e.g., legacy green screens 36, and change them to modernized web-based applications.

The data transfer migration pattern from legacy systems to cloud computing opens a promising pathway for modernization. Consumer applications such as the client applications 40 may continue to use the party API 50 to Create, Retrieve, Update, or Delete (CRUD) customer transactions. While consumers are using the party API 50, the z/OS IMS CRUD transactions are initiated. The IMS transactions use the I/O module to access IMS and DB2 databases for any CRUD requests.

While IMS and DB2 maintain the activity log 55 of these updates, a copy of IMS activities is recorded in a new DB2 activity log table. The event monitoring system 44 extracts all changes from the DB2 activity log tables at specified intervals to create “Bronze” events. A full CRUD support Microservice (i.e., BoR) is established: The Profile Bounded Context Microservice subscribes to the bronze events topic 56 to retrieve data and any data manipulations transactions.

The cloud microservice 64 can store consumer profiles, business profiles, and alternative party ID data in Azure SQL Database 76. The business logic of the legacy book of record (BoR) into the new microservice BoR may then be migrated. A profile microservice 64 may publish “Silver” events to the silver events topic 58.

To synchronize data with the existing BoR for “READ”, customer profile inquiries may be routed to the party API 50 and redirected to a new profile microservice 64 through the gateway API 74, now supported by a GraphQL contract 78.

Consumer applications can directly access the profile microservice 64 for any customer profile CRUD transactions via the gateway API 74 and GraphQL contract 78. This platform enables a gradual migration of consumers to the cloud, by redirecting party API 50 to the new microservices 64 and disconnecting party API 50 to IMS transactions. Legacy green screens 36 can transition to web/cloud-based interfaces, and batch processes can shift to event-driven models. At the later step, all mainframe batch jobs, green screens 36 and reconciliation may then be decommissioned.

The mainframe data transition design pattern offers the following benefits:

Easier, more flexible data access from anywhere and multiple access types (i.e., RESTful API and Event processing platform).

Virtually unlimited storage and computing power, enabling businesses to scale efficiently.

Reduced MIPS consumption, cutting mainframe costs with a pay-as-you-go model.

Seamless integration of modern applications, unlocking insights and improving business performance.

Faster and more cost-effective development and deployment cycles in the cloud.

Enhanced security with encryption and identity management, surpassing legacy platforms.

Real-time data inquiry and notifications for a wide range of custom consumer applications.

Use of GraphQL to allow consumer applications to access only the required data.

Minimize Legacy Dependencies: Enhanced compatibility with modern distributed systems.

Boost Data Inquiry Speed: Improve response times for more resourceful data access.

Strengthen Security & Compliance: Ensure robust protection and regulatory adherence.

Enhance Scalability: Support growth with a scalable applications and infrastructure.

Optimize Cost & Capacity: Improve operations while reducing costs through efficient capacity management.

Enable Real-Time Operations: Shift from batch processing to real-time for a superior customer experience.

Simplify Integration: Reduce complexity and cost with easier application integration.

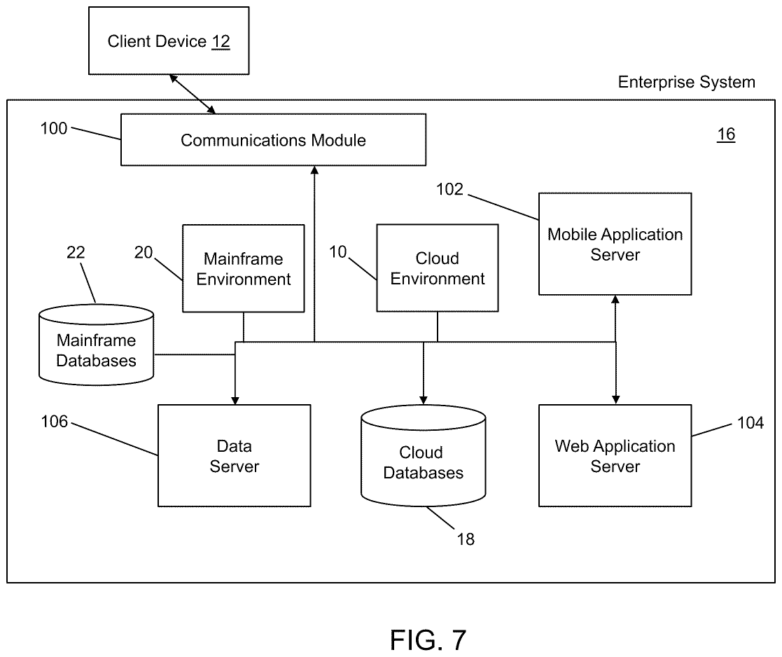

In FIG. 7, an example configuration of an enterprise system 16 is shown. The enterprise system 16 includes a communications module 100 that enables the enterprise system 16 to communicate with one or more other components of the computing environment 8, such as the cloud environment 10, mainframe environment 20, and/or client device(s) 12, via a bus or other communication network, such as the communication network 14. While not delineated in FIG. 7, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 7 illustrates examples of servers and datastores/databases operable within the enterprise system 16, e.g., the mainframe databases 22 and the cloud databases 18. It can be appreciated that any of the components shown in FIG. 7 may also be hosted externally and be available to the enterprise system 16, e.g., via the communications module 100.

In the example embodiment shown in FIG. 7, the enterprise system 16 includes one or more servers to provide access to client data from the databases 18, 22 e.g., for making decisions related to a particular client or entity (e.g., user of client device 12). Exemplary servers include a mobile application server 102, a web application server 104 and a data server 106.

Although not shown in FIG. 7, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data from the database(s) 18, 22.

Mobile application server 102 supports interactions with a mobile application installed on client device 12. Mobile application server 102 can access other resources of the enterprise system 16 to carry out requests made by, and to provide content and data to, a mobile application on client device 12. In certain example embodiments, mobile application server 102 supports a mobile banking application to provide payments from one or more accounts of user, among other things.

Web application server 104 supports interactions using a website accessed by a web browser application running on the client device. It can be appreciated that the mobile application server 102 and the web application server 104 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data in the databases 18, 22 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

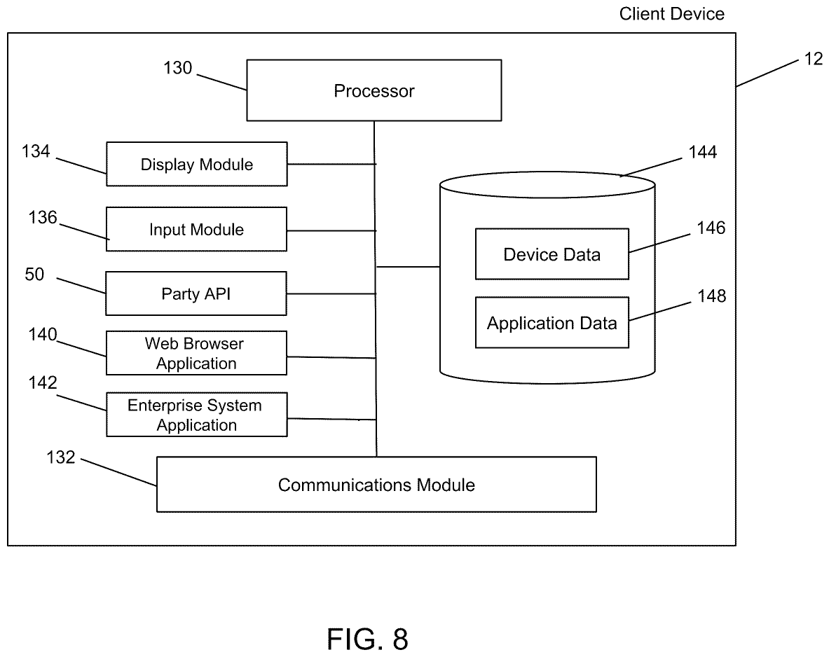

In FIG. 8, an example configuration of a client device 12 is shown. In certain embodiments, the client device 12 may include one or more processors 130, a communications module 132, and a data store 144 storing device data 146 and application data 148. Communications module 132 enables the client device 12 to communicate with one or more other components of the computing environment 8, such as the enterprise system 16, via a bus or other communication network, such as the communication network 14. While not delineated in FIG. 8, the client device 12 includes at least one memory or memory device that can include a tangible and non-transitory computer-readable medium having stored therein computer programs, sets of instructions, code, or data to be executed by processor 130. FIG. 8 illustrates examples of modules and applications stored in memory on the client device 12 and executed by the processor 130. It can be appreciated that any of the modules and applications shown in FIG. 8 may also be hosted externally and be available to the client device 12, e.g., via the communications module 132.

In the example embodiment shown in FIG. 8, the client device 12 includes a display module 134 for rendering GUIs and other visual outputs on a display device such as a display screen, and an input module 136 for processing user or other inputs received at the client device 12, e.g., via a touchscreen, input button, transceiver, microphone, keyboard, etc. The client device 12 may also include the party API 50 (or code directing the client device 12 to the party API 50), which may take the form of a customized app, plug-in, widget, or software component provided by another application or be standalone. Similarly, the client device 12 may include an enterprise system application 142 provided by the enterprise system 16. The client device 12 in this example embodiment also includes a web browser application 140 for accessing Internet-based content, e.g., via a mobile or traditional website. The data store 144 may be used to store device data 146, such as, but not limited to, an IP address or a MAC address that uniquely identifies client device 12 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 1-8 for ease of illustration and various other components would be provided and utilized by the client device 12 and enterprise system 16 as is known in the art.

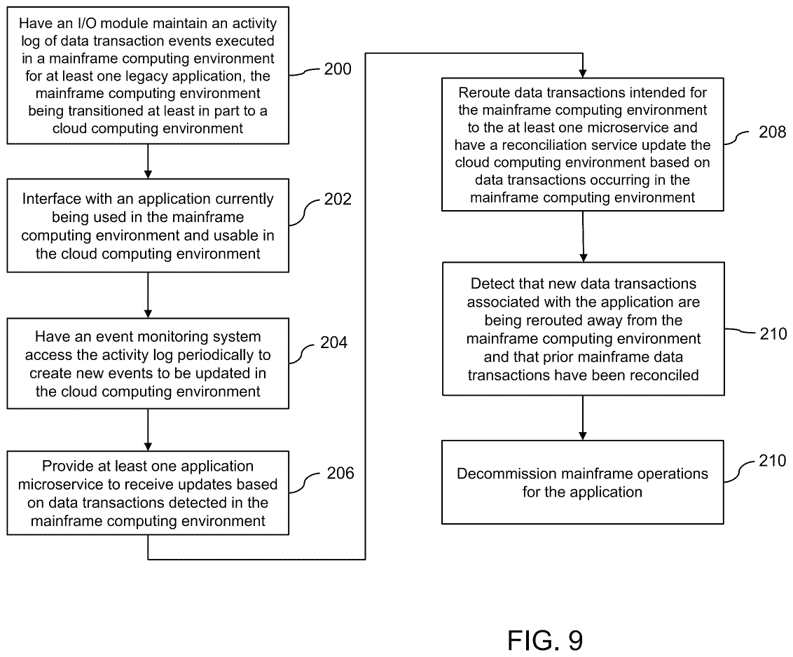

Referring now to FIG. 9, a flow chart illustrates operations that may be performed in migrating data from the mainframe environment 20 to the cloud environment 10, e.g., using the configuration shown in FIGS. 3 and 4. At block 200, the enterprise system 16 or an entity acting for the enterprise system 16 (e.g., a cloud provider) may have an I/O module such as the legacy I/O module 54 maintain an activity log 55 of data transaction events that are executed in the mainframe environment 20 for at least one legacy application, e.g., a client application 40 that interfaces with an MF application 38 as shown in FIGS. 3 and 4. The mainframe environment 20 in this scenario is being transitioned, at least in part, to the cloud environment 10 by way of a migration process or in response to a migration event.

At block 202, the migration system may interface with an application currently being used in the mainframe environment 20, e.g., MF application 38. That MF application 38 is also usable in the cloud environment 10. For example, a number of microservices 64 may have been set up to provide the same (or similar) functionality as the MF application 38 in the cloud environment 10 thus initiating a migration process by the migration system (i.e., the configuration or collection of elements operating as shown in FIGS. 3 and 4) to enable the MF application 38 to be decommissioned over time.

At block 204, the migration system has the event monitoring system 44 access the activity log 55 periodically (e.g., in a batch process or periodic service) to create new events to be updated in the cloud computing environment 10 (e.g., as described above with respect to FIGS. 3 and 4). At block 206, the migration system may provide at least one application microservice 64 to receive updates based on data transactions detected in the mainframe environment 20, e.g., as discussed above using silver and bronze event topics (56, 58) to push and pull data to/from the event hub 42.

At block 208, the migration system reroutes data transactions intended for the mainframe environment 20 to the microservice(s) 64, e.g., via the insert, inquiry, update channels and has the reconciliation service 62 update the cloud environment 10 based on data transactions occurring in the mainframe environment 20.

At block 210, the migration system detects that new data transactions associated with the client application 40 are being rerouted from the mainframe environment 20 and that prior mainframe data transactions have been reconciled. That is, at block 210, the migration system determines that the rerouting is complete such that, at block 212, the mainframe operations for the client application 40 can be decommissioned.

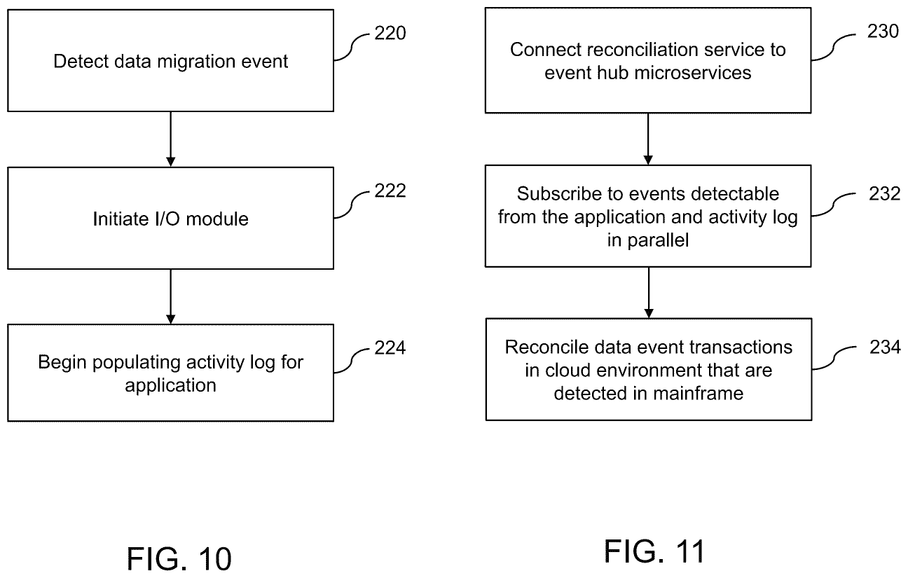

FIG. 10 is a flow chart illustrating example operations that may be performed in initiating an I/O module such as the legacy I/O module 54 to begin populating an activity log 55 for an MF application 38 being migrated to the cloud environment 10. At block 220, a data migration event is detected, e.g., when the I/O module 54 is deployed. At block 222, the I/O module 54 is initiated and, at block 224, the migration system begins to populate the activity log 55 to capture events that need to be updated in the new microservices 64 initiated for the migration and to continue operations in the cloud environment 10.

FIG. 11 is a flow chart illustrating example operations that may be performed in reconciling data event transactions in the cloud environment 10 that are detected in the mainframe environment 20. At block 230, the reconciliation service 62 is connected to the microservices (60, 62) in the event hub 42. At block 232, the event hub 42 subscribes to events detectable from the client application 40 and/or MF application 38 and from the activity log 55, in parallel. At block 234, the migration system reconciles data event transactions in the cloud environment 10 that are detected in the mainframe environment 20.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for migrating data from mainframe computing environments to cloud computing environments, the system comprising:
a processor; and
a memory coupled to the processor, the memory storing computer executable instructions that when executed by the processor cause the system to:
have an input/output (I/O) module maintain an activity log of data transaction events executed in a mainframe computing environment for at least one legacy application, the mainframe computing environment being transitioned at least in part to a cloud computing environment;
interface with an application currently being used in the mainframe computing environment and usable in the cloud computing environment;
have an event monitoring system access the activity log periodically to create new events to be updated in the cloud computing environment;
provide at least one application microservice to receive updates based on data transactions detected in the mainframe computing environment; and
reroute data transactions intended for the mainframe computing environment to the at least one microservice and have a reconciliation service update the cloud computing environment based on data transactions occurring in the mainframe computing environment,
wherein the reconciliation service subscribes to topics associated with the activity log to detect the data transaction events using the event monitoring system.

2. The system of claim 1, further comprising instructions that when executed by the processor cause the system to:
detect that new data transactions associated with the application are being rerouted away from the mainframe computing environment and that prior mainframe data transactions have been reconciled; and
decommission mainframe operations for the application.

3. The system of claim 1, wherein the activity log is utilized while data transactions are capable of being updated in the mainframe.

4. The system of claim 3, further comprising instructions that when executed by the processor cause the system to initiate the I/O module to populate the activity log for the application in response to a data migration event for the application.

5. The system of claim 1, wherein the activity log is connected to at least one legacy database in the mainframe to determine new data transaction events.

6. The system of claim 5, comprising a plurality of legacy databases, wherein the plurality of legacy databases comprises at least one information management system (IMS) database and at least one DB2 relational database.

7. The system of claim 5, wherein the at least one legacy database is utilized by at least one legacy service, at least one legacy batch job, or both.

8. The system of claim 1, further comprising instructions that when executed by the processor cause the system to:
coordinate the reconciliation service with an event hub microservice in an event hub;
subscribe to events that are detectable from the application and from the activity log in parallel; and
reconcile data event transactions in the cloud computing environment that are detected in the mainframe computing environment.

9. The system of claim 1, comprising a plurality of application microservices, wherein application microservices are created over time to add functionality to the cloud computing environment that is decommissioned from the mainframe computing environment.

10. (canceled)

11. The system of claim 1, wherein the event monitoring system is provided by infrastructure in an enterprise platform.

12. The system of claim 1, wherein the at least one microservice utilizes a GraphQL contract.

13. A method for migrating data from mainframe computing environments to cloud computing environments, the method comprising:
having an input/output (I/O) module maintain an activity log of data transaction events executed in a mainframe computing environment for at least one legacy application, the mainframe computing environment being transitioned at least in part to a cloud computing environment;
interfacing with an application currently being used in the mainframe computing environment and usable in the cloud computing environment;
having an event monitoring system access the activity log periodically to create new events to be updated in the cloud computing environment;
providing at least one application microservice to receive updates based on data transactions detected in the mainframe computing environment; and
rerouting data transactions intended for the mainframe computing environment to the at least one microservice and have a reconciliation service update the cloud computing environment based on data transactions occurring in the mainframe computing environment,
wherein the reconciliation service subscribes to topics associated with the activity log to detect the data transaction events using the event monitoring system.

14. The method of claim 13, further comprising:
detecting that new data transactions associated with the application are being rerouted away from the mainframe computing environment and that prior mainframe data transactions have been reconciled; and
decommissioning mainframe operations for the application.

15. The method of claim 13, wherein the activity log is utilized while data transactions are capable of being updated in the mainframe.

16. The method of claim 15, further comprising initiating the I/O module to populate the activity log for the application in response to a data migration event for the application.

17. The method of claim 13, wherein the activity log is connected to at least one legacy database in the mainframe to determine new data transaction events.

18. The method of claim 13, further comprising:
coordinating the reconciliation service with an event hub microservice in an event hub;
subscribing to events that are detectable from the application and from the activity log in parallel; and
reconciling data event transactions in the cloud computing environment that are detected in the mainframe computing environment.

19. The method of claim 13, comprising a plurality of application microservices, wherein application microservices are created over time to add functionality to the cloud computing environment that is decommissioned from the mainframe computing environment.

20. A non-transitory computer readable medium storing computer-executable instructions for migrating data from mainframe computing environments to cloud computing environments, comprising computer-executable instructions that, when executed by a computing system, cause the system to:
have an input/output (I/O) module maintain an activity log of data transaction events executed in a mainframe computing environment for at least one legacy application, the mainframe computing environment being transitioned at least in part to a cloud computing environment;
interface with an application currently being used in the mainframe computing environment and usable in the cloud computing environment;
have an event monitoring system access the activity log periodically to create new events to be updated in the cloud computing environment;
provide at least one application microservice to receive updates based on data transactions detected in the mainframe computing environment; and
reroute data transactions intended for the mainframe computing environment to the at least one microservice and have a reconciliation service update the cloud computing environment based on data transactions occurring in the mainframe computing environment,
wherein the reconciliation service subscribes to topics associated with the activity log to detect the data transaction events using the event monitoring system.

21. The method of claim 17, wherein the at least one legacy database is utilized by at least one legacy service, at least one legacy batch job, or both.
